(19) United States
(12) Patent Application Publication
(10) Pub. No.: US 2026/0167221 A1
(43) Pub. Date: Jun. 18, 2026

(54) METHOD, COMPUTING DEVICE AND RECORDING MEDIUM FOR GENERATING ARTIFICIAL INTELLIGENCE-BASED VEHICLE LONGITUDINAL CONTROL MODEL FOR LONGITUDINAL CONTROL OF AUTONOMOUS VEHICLES

(71) Applicant: RideFlux Inc., Jeju-si (KR)

(72) Inventors: Sanghyuk LEE, Seoul (KR); Hyunkun KIM, Goyang-si (KR); Sangjin HAN, Seoul (KR); Sungwoo PARK, Ulsan (KR)

(73) Assignee: RideFlux Inc., Jeju-si (KR)

(21) Appl. No.: 19/352,857

(22) Filed: Oct. 8, 2025

(30) Foreign Application Priority Data
Dec. 17, 2024 (KR) 10-2024-0188481

(51) Int. Cl. B60W 60/00; B60W 40/107; B60W 50/00; G05B 13/02; G07C 5/04

(52) U.S. Cl. CPC B60W 60/001; B60W 40/107; B60W 50/00; G05B 13/0265; G07C 5/04; B60W 2050/0022; B60W 2050/0031; B60W 2510/0638; B60W 2510/0666; B60W 2510/1005; B60W 2520/10; B60W 2520/105; B60W 2530/16; B60W 2540/10; B60W 2552/15; B60W 2556/10; B60W 2556/40; B60W 2556/45

(57) ABSTRACT

Provided are a method, a computing device, and a recording medium for generating an artificial intelligence-based vehicle longitudinal control model for longitudinal control of autonomous vehicles. A method of generating an artificial intelligence-based vehicle longitudinal control model for longitudinal control of autonomous vehicles according to various embodiments of the present disclosure is a method of generating an artificial intelligence-based vehicle longitudinal control model for longitudinal control of autonomous vehicles, which is performed by a computing device. The method includes acquiring driving logging data for a vehicle, generating training data using the acquired driving logging data, and generating a vehicle longitudinal control model, which derives result data for vehicle longitudinal control, using the generated training data.

### CROSS-REFERENCE TO RELATED APPLICATION

This application claims priority to and the benefit of Korean Patent Application No. 10-2024-0188481, filed on Dec. 17, 2024, the disclosure of which is incorporated herein by reference in its entirety.

### BACKGROUND

### 1. Field of the Invention

Various embodiments of the present disclosure relate to a method, computing device, and recording medium for generating an artificial intelligence-based vehicle longitudinal control model for longitudinal control of autonomous vehicles.

### 2. Discussion of Related Art

For the convenience of a user driving a vehicle, various sensors, electronic devices, and the like (e.g., an advanced driver assistance system (ADAS)) are being provided, and in particular, technology development for an autonomous driving system for a vehicle that recognizes the surrounding environment without driver intervention and automatically drives to a given destination according to the recognized surrounding environment is actively underway.

An autonomous vehicle is a vehicle equipped with an autonomous driving system function that recognizes the surrounding environment without driver intervention and automatically drives to a given destination based on the recognized surrounding environment. The autonomous driving system function means performing positioning, recognition, prediction, planning, and control for autonomous driving.

The autonomous driving system processes point cloud data acquired through sensors (e.g., a LiDAR sensor) using a recognition process to detect objects located around the autonomous vehicle, and receives recognition results (e.g., information on positions, attitudes, and speeds of the objects) derived by performing the recognition process to establish a driving plan, such as a path and speed of the autonomous vehicle.

The above-described background art is a technology possessed or acquired by the inventors in the process of deriving the content of the present disclosure and may not necessarily have been considered a publicly disclosed technology prior to the present application.

### SUMMARY OF THE INVENTION

In order to design a system for vehicle longitudinal control (e.g., speed control) in an autonomous driving system, it is necessary to mathematically model a vehicle dynamics model.

However, since the vehicle dynamics model should accurately reflect the complex physical characteristics of the vehicle and the influence of the external environment, there is difficulty in mathematically modeling the vehicle dynamics model. For example, vehicle dynamics are nonlinearly influenced by various factors such as speed, acceleration, and resistance. In modeling the vehicle dynamics, factors such as engine, transmission, tire friction, and air resistance should be considered, thereby increasing the complexity of the model.

Conventionally, these vehicle dynamics models were solved through differential equation modeling. However, this method suffers from the problem of requiring significant time, cost, and effort in determining the parameters of the differential equations. For example, to determine the parameters of the differential equations, it is necessary to acquire actual vehicle driving data and individually map the correlations between these data. Therefore, this process requires significant time, resources, and effort.

Accordingly, the present disclosure is directed to providing a method, a computing device, and a recording medium for generating an artificial intelligence-based vehicle longitudinal control model for longitudinal control of autonomous vehicles capable of more efficiently designing a vehicle longitudinal control model by constructing an artificial intelligence-based vehicle longitudinal control model capable of deriving information for vehicle longitudinal control based on target acceleration of the vehicle and vehicle status information, and performing the vehicle longitudinal control based on the derived result data.

The problems to be solved by the present disclosure are not limited to the above-mentioned problems, and other problems that are not mentioned may be obviously understood by those skilled in the art from the following description.

A method of generating an artificial intelligence-based vehicle longitudinal control model for longitudinal control of autonomous vehicles according to various embodiments of the present disclosure is a method of generating an artificial intelligence-based vehicle longitudinal control model for longitudinal control of autonomous vehicles, which is performed by a computing device. The method includes acquiring driving logging data for a vehicle, generating training data using the acquired driving logging data, and generating a vehicle longitudinal control model, which derives result data for vehicle longitudinal control, using the generated training data.

The generating of the training data may include: acquiring target acceleration from the acquired driving logging data; acquiring vehicle status information from the acquired driving logging data; acquiring accelerator pedal position information from the acquired driving logging data; and generating training data that includes the acquired target acceleration and the acquired vehicle status information as input data and the acquired accelerator pedal position information as ground truth data.

The acquiring of the target acceleration may include acquiring an acceleration measured from the vehicle at a second point in time, which is a predetermined period of time after a first point in time, as target acceleration at the first point in time.

The acquiring of the target acceleration may include acquiring an average value of accelerations measured from the vehicle over a predetermined period of time after a specific point in time as target acceleration at the specific point in time.

The acquiring of the vehicle status information may include acquiring information on a longitudinal speed, engine revolutions per minute (RPM), and a gear state of the vehicle from the acquired driving logging data as the vehicle status information.

The acquiring of the vehicle status information may include acquiring at least one of slope information of the vehicle and slope change information of the vehicle from the acquired driving logging data as the vehicle status information.

The generating of the training data may include: acquiring driving environment information while the vehicle is driving based on previously generated precision map data; and generating the training data using the acquired driving environment information and the acquired driving logging data, and the acquired driving environment information includes at least one of a gradient and a gradient change amount of a location where the vehicle is driving.

The generating of the training data using the acquired driving environment information and the acquired driving logging data may include: acquiring at least one of slope information and slope change information of the vehicle as vehicle status information based on the gradient and the gradient change amount of the location where the vehicle is driving; and generating the training data using the at least one acquired information and the acquired driving logging data.

The generated vehicle longitudinal control model may be a long short-term memory (LSTM) model.

The generating of the training data may include: acquiring target acceleration from the acquired driving logging data; acquiring vehicle status information from the acquired driving logging data; extracting an estimated acceleration corresponding to the acquired target acceleration and the acquired vehicle status information; and generating training data that includes the acquired target acceleration and the acquired vehicle status information as input data and the extracted estimated acceleration as ground truth data, and the generating of the vehicle longitudinal control model may include generating the vehicle longitudinal control model that derives an optimal combination of parameter functions constituting a vehicle longitudinal model derived from a vehicle dynamics model by training the vehicle longitudinal control model using the generated training data.

The generating of the vehicle longitudinal control model that derives the optimal combination of parameter functions constituting the vehicle longitudinal model may include: when the vehicle longitudinal model includes a plurality of parameter functions, generating a plurality of neural network models as unit models for each of the plurality of parameter functions; and generating a single vehicle longitudinal control model including the plurality of generated neural network models.

The vehicle dynamics model may be expressed as in the following Equation 1.

$${F}_{u} - {R}_{roll} - {R}_{air} - {R}_{g} - {R}_{a} = 0 \qquad < Equation 1 >$$

Here, Fᵤ may denote engine power, Rᵣₒₗₗ may denote rolling resistance, Rₐᵢᵣ may denote air resistance, R_{g} may denote climbing resistance, and Ra may denote inertial resistance.

The vehicle longitudinal model may be expressed as in the following Equation 2 below.

$$\dot{v} = - λ ( g ) {θ}_{0} - λ ( g ) {θ}_{v} ( v ) {v}^{2} + b ( g , APS \% ) \frac{APS \%}{100} \qquad < Equation 2 >$$

Here, \dot{v} may denote the vehicle longitudinal control model, λ(g) may denote a parameter function related to a gear scaling factor depending on a gear state, θ₀ may denote a static parameter related to a gear, g may denote the gear state, θᵥ(v) may denote a gear parameter function depending on a speed, v may denote the speed, APS % may denote an accelerator pedal position value, and b(g,APS %) may denote a DC gain function that varies depending on an accelerator pedal position value and the gear state.

The derived optimal combination of the parameter functions may include a parameter function related to a gear scaling factor depending on a gear state, a parameter function related to a gear, and a parameter function related to a DC gain that varies depending on an accelerator pedal position value and the gear state.

The generating of the training data may include: preprocessing the acquired driving logging data; and generating the training data using the preprocessed driving logging data.

According to another aspect of the present invention, there is provided computing device that performs a method of generating an artificial intelligence-based vehicle longitudinal control model for longitudinal control of autonomous vehicles, which includes: a processor; a network interface; a memory; and a computer program loaded into the memory and executed by the processor, in which the computer program includes: an instruction to acquire driving logging data for a vehicle; an instruction to generate training data using the acquired driving logging data; and an instruction to generate a vehicle longitudinal control model, which derive result data for vehicle longitudinal control, using the generated training data.

According to still another aspect of the present invention, there is provided a computer program stored in a recording medium readable by a computing device, which is coupled to the computing device, to execute a method of generating an artificial intelligence-based vehicle longitudinal control model for longitudinal control of an autonomous vehicle, in which the method includes: acquiring driving logging data for a vehicle; generating training data using the acquired driving logging data; and generating a vehicle longitudinal control model, which derives result data for vehicle longitudinal control, using the generated training data.

Other specific details of the present disclosure are included in the detailed description and drawings.

### BRIEF DESCRIPTION OF THE DRAWINGS

The following drawings attached to this specification illustrate preferred embodiments of the present disclosure, and serve to further understand the technical idea of the present disclosure together with the detailed description of the invention described below, so the present disclosure should not be interpreted as being limited to matters described in such drawings:

FIG. 1 is a diagram illustrating an autonomous driving system according to an embodiment of the present disclosure;

FIG. 2 is a diagram illustrating a hardware configuration of a computing device according to another embodiment of the present disclosure;

FIG. 3 is a flowchart illustrating a method of generating a first artificial intelligence-based vehicle longitudinal control model for longitudinal control of autonomous vehicles, according to various embodiments;

FIG. 4 is an exemplary diagram of preprocessed driving logging data applicable to various embodiments;

FIG. 5 is a diagram illustrating a first vehicle longitudinal control model applicable to various embodiments;

FIG. 6 is a schematic diagram illustrating a network function related to one embodiment of the present disclosure;

FIG. 7 is an exemplary diagram of a long short-term memory (LSTM) model applicable to various embodiments;

FIGS. 8A to 8E and 9A to 9B are diagrams illustrating learning results of a vehicle longitudinal control model according to various embodiments;

FIGS. 10A to 10C is a diagram illustrating experimental results of a vehicle longitudinal control model trained according to various embodiments;

FIG. 11 is a flowchart illustrating a method of generating a second artificial intelligence-based vehicle longitudinal control model for longitudinal control of autonomous vehicles, according to various embodiments;

FIG. 12 is a diagram illustrating a second vehicle longitudinal control model applicable to various embodiments; and

FIG. 13 is a diagram illustrating a vehicle longitudinal model applicable to various embodiments.

### DETAILED DESCRIPTION OF EXEMPLARY EMBODIMENTS

Various advantages and features of the present disclosure and methods accomplishing them will become apparent from the following description of embodiments with reference to the accompanying drawings. However, the present disclosure is not limited to embodiments to be described below, but may be implemented in various different forms, these embodiments will be provided only in order to make the present disclosure complete and allow those skilled in the art to completely recognize the scope of the present disclosure, and the present disclosure will be defined by the scope of the claims.

Terms used in the present specification are for explaining embodiments rather than limiting the present disclosure. Unless otherwise stated, a singular form includes a plural form in the present specification. Throughout this specification, the term “comprise” and/or “comprising” will be understood to imply the inclusion of stated constituents but not the exclusion of any other constituents.

Like reference numerals refer to like components throughout the specification and “and/or” includes each of the components mentioned and includes all combinations thereof. Although “first,” “second,” and the like are used to describe various components, it goes without saying that these components are not limited by these terms. These terms are used only to distinguish one component from other components. Therefore, it goes without saying that a first component mentioned below may be a second component within the technical scope of the present disclosure.

The term “unit” or “module” used in the specification refers to a software component or a hardware component such as a field programmable gate array (FPGA) or an application-specific integrated circuit (ASIC), and the “unit” or “module” performs certain roles. However, the term “unit” or “module” is not intended to be limited to software or hardware. A “unit” or “module” may be configured to be stored in a storage medium that can be addressed or may be configured to regenerate one or more processors. Accordingly, for example, a “unit” or “module” includes components such as software components, object-oriented software components, class components, and task components, processors, functions, attributes, procedures, subroutines, segments of a program code, drivers, firmware, a microcode, a circuit, data, a database, data structures, tables, arrays, and variables. Functions provided in components, “units,” or “modules” may be combined into fewer components, “units,” or “modules” or further separated into additional components, “units,” or “modules.”

Spatially relative terms “below,” “beneath,” “lower,” “above,” “upper,” and the like may be used to easily describe the correlation between one component and other components as illustrated in drawings. The spatially relative terms should be understood as terms including different directions of components during use or operation in addition to the directions illustrated in the drawings. For example, when components illustrated in the drawings are turned over, a component described as “below” or “beneath” another component may then be placed “above” the other component. Therefore, the illustrative term “below” can include both downward and upward directions. The components can also be aligned in different directions, and therefore the spatially relative terms can be interpreted according to the alignment.

As described herein, unless the context clearly indicates otherwise, the expressions “first,” “second,” or “1^{st},” “2^{nd},” etc., are used to distinguish one object from another when referring to multiple similar objects, and do not limit the order or importance among the corresponding objects.

As used herein, the expressions “A, B, and C,” “A, B, or C,” “A, B, and/or C,” “at least one of A, B, and C,” “at least one of A, B, or C,” “at least one of A, B, and/or C,” “at least one selected from A, B, and C,” “at least one selected from A, B, or C,” “at least one selected from A, B, and/or C,” etc., may refer to each listed item or all possible combinations of the listed items. For example, “at least one selected from A and B” may refer to (1) A, (2) at least one of A, (3) B, (4) at least one of B, (5) at least one of A and at least one of B, (6) at least one of A and B, (7) at least one of B and A, or (8) both A and B.

As used herein, the expression “based on” is used to describe one or more factors that influence a decision, determination, or action described in a phrase or a sentence containing the corresponding expression, and this expression does not exclude additional factors that influence the corresponding decision, determination, or action.

As used herein, the expression that a component (e.g., a first component) is “connected” or “coupled” to another component (e.g., a second component) may mean not only that the component is directly connected or coupled to the other component, but also that the component is connected or coupled via a new other component (e.g., a third component).

The expression “configured to” used herein may have various meanings, such as “set to,” “having the ability to,” “modified to,” “made to,” and “capable of” depending on the context. The expression is not limited to the meaning of “specifically designed in hardware.” For example, a processor configured to perform a specific operation may refer to a general-purpose processor capable of performing the specific operation by executing software.

Unless defined otherwise, all terms (including technical and scientific terms) used in the present specification have the same meanings commonly understood by those skilled in the art to which the present disclosure pertains. In addition, terms defined in commonly used dictionaries are not ideally or excessively interpreted unless explicitly defined otherwise.

In this specification, the computer means all kinds of hardware devices including at least one processor and can be understood as including a software configuration which is operated in the corresponding hardware device according to the embodiment. For example, the computer may be understood as a meaning including all of smart phones, tablet PCs, desktops, notebooks, and user clients and applications running on each device, but is not limited thereto.

Hereinafter, embodiments of the present disclosure will be described in detail with reference to the accompanying drawings.

Each step described in the present disclosure is described as being performed by a computer, but subjects of each step are not limited thereto, and according to embodiments, at least some steps can also be performed on different devices.

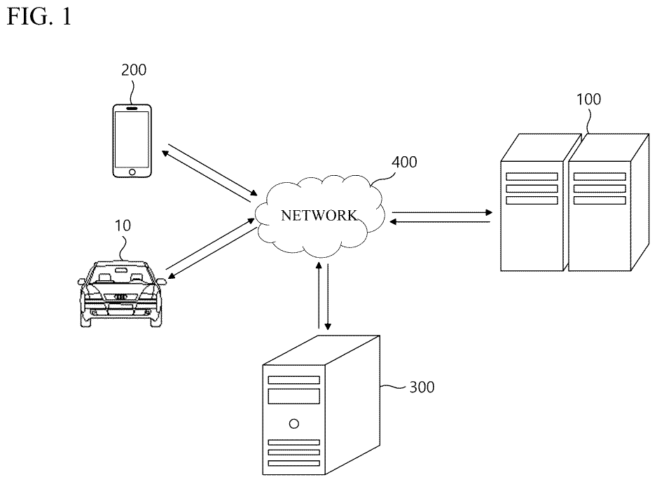

FIG. 1 is a diagram illustrating an autonomous driving system according to an embodiment of the present disclosure.

Referring to FIG. 1, an autonomous driving system according to an embodiment of the present disclosure may include a computing device 100, a user terminal 200, an external server 300, and a network 400.

Here, the autonomous driving system illustrated in FIG. 1 is according to an embodiment, and components of the autonomous driving system are not limited to the embodiment illustrated in FIG. 1, and some components may be added, changed, or deleted as necessary.

In one embodiment, the computing device 100 may perform autonomous driving control for a vehicle 10. To this end, the computing device 100 may perform a positioning operation, a recognition operation, a planning operation, and a control operation.

Here, according to the autonomous driving system illustrated in FIG. 1, the computing device 100 may be separately installed outside the vehicle 10, determine a control command related to autonomous driving from the outside of the vehicle 10, and transmit the control command related to the autonomous driving to the vehicle 10, thereby enabling the vehicle 10 to perform the autonomous driving operation. However, the present disclosure is not limited thereto, and the computing device 100 may correspond to one of components installed inside the vehicle 10, determine a control command related to the autonomous driving from the inside of the vehicle 10, and directly control the components of the vehicle 10 according to the control command related to the autonomous driving, thereby performing the autonomous driving control for the vehicle 10. For example, the computing device 100 may be a control module that controls the operations of the components included in the vehicle 10 within the vehicle 10.

More specifically, the positioning operation performed by the computing device 100 may be an operation of measuring the position and attitude of the vehicle 10. For example, the computing device 100 may collect sensor data (e.g., point cloud data, image data, etc.) by scanning the surrounding environment of the vehicle 10 using sensors (e.g., a LiDAR, a RADAR, a camera, a global navigation satellite system (GNSS)/inertial navigation system (INS), and inertial measurement unit (IMU), etc.) provided in the vehicle 10, and derive positioning information including positioning values corresponding to the position and attitude of the vehicle 10 by utilizing the collected sensor data.

Next, the recognition operation performed by the computing device 100 may be an operation of detecting and tracking an object located near the vehicle 10. For example, the computing device 100 may recognize an object existing near the vehicle 10 by analyzing sensor data (e.g., LiDAR data and image data, etc.) collected by scanning the surroundings of the vehicle 10 and derive recognition information including information on the recognized object.

Next, the planning operation performed by the computing device 100 may be an operation of generating a driving plan including a path and a speed profile for controlling the vehicle 10 based on the positioning information derived from the positioning module and the recognition information derived from the recognition module.

Finally, the control operation performed by the computing device 100 may be an operation of determining and generating control commands for lateral control (direction control) and longitudinal control (speed control) of the vehicle 10 based on information on a driving plan derived from the planning operation, and controlling the operation of the vehicle 10 according to the determined and generated control commands.

In various embodiments, the computing device 100 may derive result data for vehicle longitudinal control based on a vehicle longitudinal control model and perform longitudinal control of the vehicle 10 based on the derived result data. To this end, the computing device 100 may generate training data based on driving logging data for the vehicle 10 and generate the vehicle longitudinal control model that derives result data for vehicle longitudinal control based on the generated training data.

In various embodiments, the computing device 100 can be connected to the user terminal 200 via the network 400 and provide various pieces of information related to autonomous driving to the user terminal 200.

Here, the user terminal 200 may refer to any form of entity(ies) in a system having a mechanism for communicating with the computing device 100. For example, the user terminal 200 may include a personal computer (PC), a notebook, a mobile terminal, a smart phone, a tablet PC, a wearable device, etc., and may include all types of terminals capable of connecting to wired/wireless networks. In addition, the user terminal 200 may include any computing device implemented by at least one of an agent, an application programming interface (API), and a plug-in. In addition, the user terminal 200 may include application sources and/or client applications.

In addition, here, the network 400 may be a connection structure capable of exchanging information between respective nodes such as a plurality of terminals and servers. For example, the network 400 may include a local area network (LAN), a wide area network (WAN), the Internet (World Wide Web (WWW)), a wired/wireless data communication network, a telephone network, a wired/wireless television communication network, a controller area network (CAN), Ethernet, or the like.

Examples of the wireless data communication network may include 3^{rd} generation (3G), 4^{th} generation (4G), 5^{th} generation (5G), 3^{rd} Generation Partnership Project (3GPP), 5th Generation Partnership Project (5GPP), Long Term Evolution (LTE), World Interoperability for Microwave Access (WiMAX), Wi-Fi, the Internet, a LAN, a wireless local area network (WLAN), a WAN, a personal area network (PAN), radio frequency, a Bluetooth network, a near-field communication (NFC) network, a satellite broadcast network, an analog broadcast network, a digital multimedia broadcasting (DMB) network, and the like, but are not limited thereto.

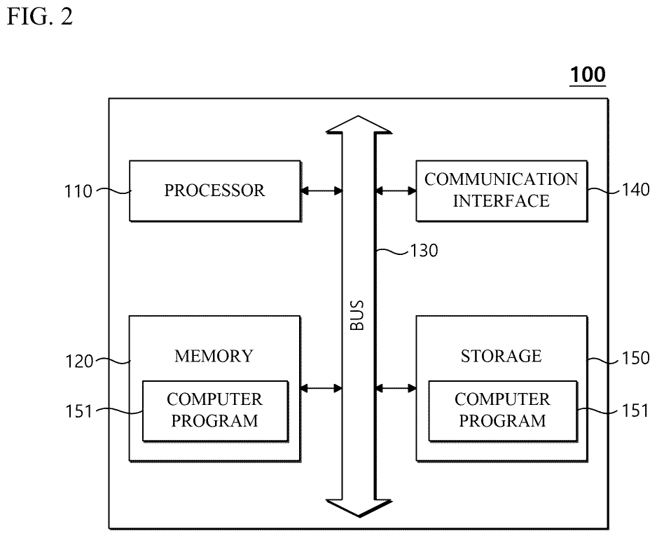

In an embodiment, the external server 300 may be connected to the computing device 100 via the network 400 and may store and manage various pieces of information and data necessary for the computing device 100 to perform the method of generating an artificial intelligence-based vehicle longitudinal control model for longitudinal control of autonomous vehicles, or may collect, store, and manage various pieces of information and data derived as the computing device 100 performs the method of generating an artificial intelligence-based vehicle longitudinal control model for longitudinal control of autonomous vehicles. For example, the external server 300 may be a storage server separately provided outside the computing device 100 but is not limited thereto. Hereinafter, the hardware configuration of the computing device 100 that performs the method of generating an artificial intelligence-based vehicle longitudinal control model for longitudinal control of autonomous vehicles will be described with reference to FIG. 2.

FIG. 2 is a diagram illustrating a hardware configuration of a computing device according to another embodiment of the present disclosure.

Referring to FIG. 2, according to other embodiments of the present disclosure, the computing device 100 may include one or more processors 110, a memory 120 into which a computer program 151 executed by the processor 110 is loaded, a bus 130, a communication interface 140, and a storage 150 for storing the computer program 151. Here, only the components related to the embodiment of the present disclosure are illustrated in FIG. 2. Accordingly, those skilled in the art to which the present disclosure pertains may understand that general-purpose components other than those illustrated in FIG. 2 may be further included.

The processor 110 controls an overall operation of each component of the computing device 100. The processor 110 may be configured to include a central processing unit (CPU), a micro processor unit (MPU), a micro controller unit (MCU), a graphics processing unit (GPU), or any type of processor well known in the art of the present disclosure.

In addition, the processor 110 may perform an operation on at least one application or program for executing the method according to the embodiments of the present disclosure, and the computing device 100 may include one or more processors.

According to various embodiments, the processor 110 may further include a random access memory (RAM) (not illustrated) and a read-only memory (ROM) for temporarily and/or permanently storing signals (or data) processed in the processor 110. In addition, the processor 110 may be implemented in the form of a system-on-chip (SoC) including at least one of a graphics processing unit, a RAM, and a ROM.

The memory 120 stores various types of data, commands and/or information. The memory 120 may load the computer program 151 from the storage 150 to execute methods/operations according to various embodiments of the present disclosure. When the computer program 151 is loaded into the memory 120, the processor 110 may perform the method/operation by executing one or more instructions constituting the computer program 151. The memory 120 may be implemented as a volatile memory such as a RAM, but the technical scope of the present disclosure is not limited thereto.

The bus 130 provides a communication function between the components of the computing device 100. The bus 130 may be implemented as various types of buses, such as an address bus, a data bus, and a control bus.

The communication interface 140 supports wired/wireless Internet communication of the computing device 100. In addition, the communication interface 140 may support various communication methods other than the Internet communication. To this end, the communication interface 140 may be configured to include a communication module well known in the art of the present disclosure. In some embodiments, the communication interface 140 may be omitted.

The storage 150 may non-temporarily store the computer program 151. When performing a process for generating an artificial intelligence-based vehicle longitudinal control model for longitudinal control of autonomous vehicles through the computing device 100, the storage 150 may store various types of information necessary to provide the process for generating an artificial intelligence-based vehicle longitudinal control model for longitudinal control of autonomous vehicles.

The storage 150 may be configured to include a nonvolatile memory, such as a ROM, an erasable programmable ROM (EPROM), an electrically erasable programmable ROM (EEPROM), and a flash memory, a hard disk, a removable disk, or any well-known computer-readable recording medium in the art to which the present disclosure belongs.

The computer program 151 may include one or more instructions to cause the processor 110 to perform methods/operations according to various embodiments of the present disclosure when loaded into the memory 120. That is, the processor 110 may perform the method/operation according to various embodiments of the present disclosure by executing the one or more instructions.

In an embodiment, the computer program 151 may include one or more instructions that cause the computer program 151 to perform a method of generating an artificial intelligence-based vehicle longitudinal control model for longitudinal control of autonomous vehicles, and includes acquiring driving logging data for a vehicle, generating training data using the acquired driving logging data, and generating a vehicle longitudinal control model that derives result data for vehicle longitudinal control using the generated training data.

Operations of the method or algorithm described with reference to the embodiment of the present disclosure may be directly implemented in hardware, in software modules executed by hardware, or in a combination thereof. The software module may reside in a RAM, a ROM, an EPROM, an EEPROM, a flash memory, a hard disk, a removable disk, a compact disc ROM (CD-ROM), or in any form of computer-readable recording medium known in the art to which the present disclosure pertains.

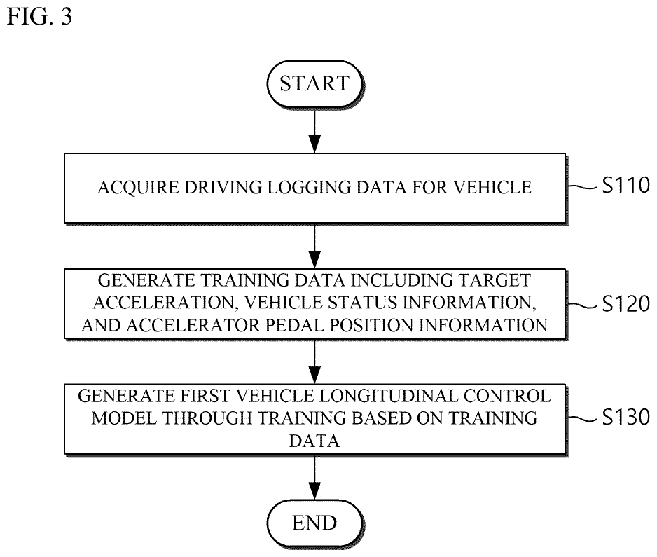

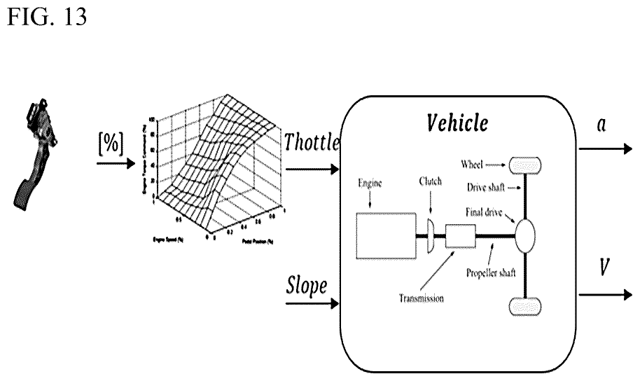

The components of the present disclosure may be embodied as a program (or application) and stored in a medium for execution in combination with a computer which is hardware. The components of the present disclosure may be executed in software programming or software elements, and similarly, embodiments may be realized in a programming or scripting language such as C, C++, Java, and an assembler, including various algorithms implemented in a combination of data structures, processes, routines, or other programming constructions. Functional aspects may be implemented in algorithms executed on one or more processors. Hereinafter, a method of generating an artificial intelligence-based vehicle longitudinal control model for longitudinal control of autonomous vehicles performed by the computing device 100 will be described with reference to FIGS. 3 to 13.

FIG. 3 is a flowchart illustrating the method of generating a first artificial intelligence-based vehicle longitudinal control model for longitudinal control of autonomous vehicles, according to various embodiments.

Referring to FIG. 3, in operation S110, the computing device 100 may acquire the driving logging data for the vehicle 10.

Here, the driving logging data for the vehicle 10 is data collected through various sensors installed in the vehicle 10 while the vehicle 10 is driving and may be data recording the operation and environmental information of the vehicle 10. For example, the driving logging data may include the operation and test environmental information of the vehicle 10 collected while the vehicle 10 performs a test drive, or the operation and actual environmental information of the vehicle 10 collected while the vehicle 10 performs an actual drive.

For example, the driving logging data may include data collected via an electronic control unit (ECU) (e.g., control signal data such as an engine and gear state of the vehicle 10, accelerator pedal position information (APS %), etc.), data collected via an IMU (e.g., speed, acceleration, slope angle, etc., of the vehicle 10), data collected via GPS (e.g., location information and altitude data), and data collected via other sensors (e.g., road environment information (gradient, obstacles, etc.) collected through a LiDAR/camera, brake operation status and strength collected through brake sensors, etc.).

In addition, the driving logging data may include sensor data (e.g., point cloud data collected in real time via a LiDAR sensor) collected in real time from the vehicle 10 and positioning result data obtained by matching precise map data corresponding to the location where the vehicle 10 is driving.

In operation S120, the computing device 100 may generate training data using the driving logging data acquired through operation S110.

In various embodiments, the computing device 100 may generate training data for training a first vehicle longitudinal control model.

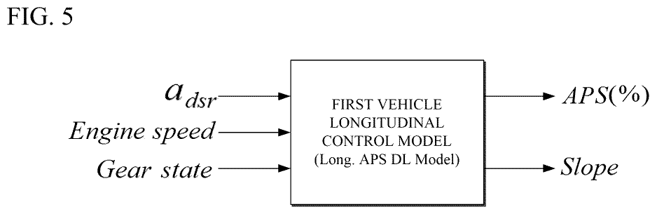

Here, the first vehicle longitudinal control model is a model that derives result data for longitudinal control of the vehicle 10. As illustrated in FIG. 5, the first vehicle longitudinal control model is a model that derives accelerator pedal position information (APS (%)) using target acceleration (a_{dsr}) of the vehicle 10 and vehicle status information as inputs. The training data may be data including the target acceleration, the vehicle status information, and the accelerator pedal position information.

Here, the vehicle longitudinal control may be a concept that includes not only acceleration control of the vehicle but also deceleration control of the vehicle.

When a driver directly operates an accelerator pedal and a brake pedal, the accelerator pedal is not used when the brake pedal is used, and the brake pedal is not used when the accelerator pedal is used, so the accelerator and brake pedals are used mutually exclusively. However, when controlling the vehicle 10 according to the autonomous driving system, the accelerator and brake pedals may be operated simultaneously depending on the situation, so an acceleration model for acceleration control of the vehicle and a deceleration model for deceleration control of the vehicle may be designed separately.

Considering this, the training data for training the first vehicle longitudinal control model may further include not only accelerator pedal position information, i.e., accelerator pedal position information for designing an acceleration model, but also brake pedal (deceleration pedal) position information for designing deceleration control. However, the present disclosure is not limited thereto.

More specifically, first, the computing device 100 may acquire the target acceleration from the driving logging data.

In the vehicle control system, due to the mechanisms of the engine and powertrain (the inertia of gears, shafts, tires, etc.), even with an input for acceleration (e.g., changing the position of the accelerator pedal), the engine response is delayed due to factors like mechanical inertia, the operation of the engine throttle and powertrain mechanisms, turbo lag, etc.

That is, even when the accelerator pedal is operated to achieve target acceleration at a specific point in time, the response delay prevents the vehicle 10 from immediately reaching its target acceleration, causing a delay. Consequently, the acceleration measured at the specific point in time may mismatch the target acceleration at the corresponding point in time.

Considering the response delay, the computing device 100 may determine, based on the specific point in time, an acceleration measured at a future point in time as the target acceleration at the corresponding specific point in time.

For example, the computing device 100 may acquire the acceleration measured from the vehicle 10 at a second point in time, which is a predetermined period of time after a first point in time, as the target acceleration at the first point in time.

As another example, the computing device 100 may acquire, as the target acceleration at the specific point in time, an average value of the accelerations measured from the vehicle 10 over a predetermined period of time after the specific point in time.

Next, the computing device 100 may acquire the vehicle status information from the driving logging data.

Here, the vehicle status information may include, but is not limited to, information on a longitudinal speed, engine revolutions per minute (RPM), and a gear state of the vehicle 10.

In various embodiments, the computing device 100 may acquire slope information (e.g., pitch angle) and slope change information (e.g., pitch angle change amount) of the vehicle 10 as the vehicle status information.

Even when the position of the accelerator pedal of the vehicle 10 is the same, the acceleration of the vehicle 10 differs when driving on a flat section and when driving on a slope section. Considering this, by including the slope information of the vehicle 10 in the training data for training the first vehicle longitudinal control model, in the process of deriving result data for the longitudinal control of the vehicle 10 through the first vehicle longitudinal control model, the result data may be output in consideration of the slope of the environment in which the vehicle 10 is currently traveling.

Furthermore, although the accelerator pedal position information of the vehicle 10 has been adjusted based on the driving logging data for the vehicle 10, it is necessary to distinguish whether the adjustment of the accelerator pedal position information is for adjusting the target acceleration or for maintaining the target acceleration even in slope sections existing on a driving path, in preparation for the slope sections.

Considering this, in addition to the slope information of the vehicle 10, the slope change amount of the vehicle 10 may be included in the training data for training the first vehicle longitudinal control model.

The slope information and the slope change information of the vehicle 10 may be acquired based on the driving logging data for the vehicle 10, such as by extracting the vehicle pitch angle included in the driving logging data to acquire the slope information, or by calculating the difference in the vehicle pitch angle at different points in time to acquire the slope change information, but the present disclosure is not limited thereto. A gradient and a gradient change amount of the location where the vehicle 10 is driving may be acquired based on previously generated precision map data, and the slope information and slope change information of the vehicle 10 may be acquired based on the acquired gradient and gradient change amount.

Next, the computing device 100 may acquire the accelerator pedal position information (APS (%)) from the driving logging data.

Here, the accelerator pedal position information indicates the degree to which the accelerator pedal is pressed and may be expressed as a percentage of the pedal position. For example, the position of the accelerator pedal may be expressed as a percentage, with 0% being a state where the accelerator pedal is not pressed at all, and 100% being a state (maximum output) where the pedal is fully pressed.

Typically, in an electronic throttle control (ETC) or drive-by-wire system, an electric signal corresponding to the amount of pressure applied to the accelerator pedal is generated, and a fuel injection throttle is adjusted based on the electric signal, thereby controlling the acceleration of the vehicle 10. Therefore, the amount of pressure applied to the pedal may be estimated based on the amount of pressure applied to the fuel injection throttle and/or the electric signal used to determine the amount of pressure applied to the fuel injection throttle, thereby acquiring the accelerator pedal position information.

Next, the computing device 100 may generate the training data that includes the target acceleration and the acquired vehicle status information as input data, and the accelerator pedal position information as ground truth data.

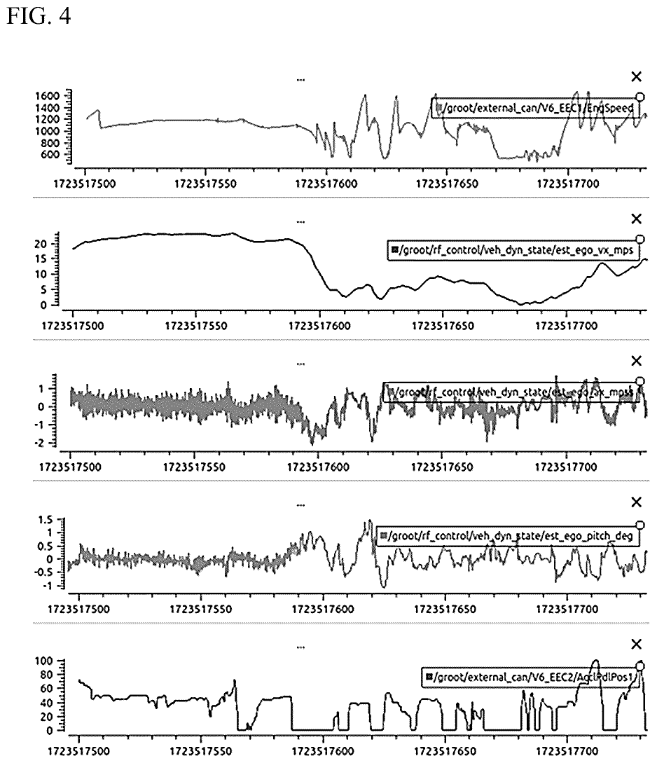

In various embodiments, the computing device 100 may preprocess the driving logging data (e.g., FIG. 4) and generate the training data based on the preprocessed driving logging data.

Here, the preprocessing may be data scaling (e.g., standard scaling) of adjusting data values to a certain range and outlier removal (outlier data) of identifying and removing outliers that are outside of an average pattern, but is not limited thereto.

In operation S130, the computing device 100 may train the first vehicle longitudinal control model using the training data generated through operation S120, thereby generating the first vehicle longitudinal control model that outputs the accelerator pedal position information (APS (%)) using the target acceleration and the vehicle status information as the input data.

Here, the first vehicle longitudinal control model (e.g., a neural network) is composed of one or more network functions, and the one or more network functions may be composed of a set of interconnected computational units that may generally be referred to as “nodes.” These “nodes” may also be referred to as “neurons.” One or more network functions are configured to include one or more nodes. The nodes (or neurons) that constitute one or more network functions may be interconnected by one or more “links.”

Within the first vehicle longitudinal control model, one or more nodes connected via links may form the relative relationships between input nodes and output nodes. The concepts of the input nodes and the output nodes are relative, meaning that any node in an output node relationship with one node may also be in an input node relationship with another node, and vice versa. As described above, the relationships between the input nodes and the output nodes may be generated around the links. One input node may be connected to one or more output nodes via the links, and vice versa.

In the relationship between the input node and the output node connected via a single link, the value of the output node may be determined based on the data input to the input node. Here, the node interconnecting the input node and the output node may have a weight. The weight may be variable and may vary with a user or an algorithm to allow the first vehicle longitudinal control model to perform the desired function. For example, when one or more input nodes are interconnected to one output node via each link, the value of the output node may be determined based on the values input to the input nodes connected to the output node and the weights set for the links corresponding to each input node.

As described above, the first vehicle longitudinal control model forms the relationship between the input node and the output node within the first vehicle longitudinal control model by interconnecting one or more nodes via one or more links. The characteristics of the first vehicle longitudinal control model may be determined based on the numbers of nodes and links, the relationships between the nodes and links, and the weights assigned to each link within the first vehicle longitudinal control model. For example, when there are two first vehicle longitudinal control models having the same numbers of nodes and links but different weight values between the links, the two first vehicle longitudinal control models may be recognized as different from each other.

Some of the nodes constituting the first vehicle longitudinal control model may constitute one layer based on their distances from an initial input node. For example, a set of nodes that are a distance n from the initial input node may constitute a layer n. The distance from the initial input node may be defined by the minimum number of links required to reach the corresponding node from the initial input node. However, this definition of the layer is arbitrary for illustrative purposes, and the degree of the layer within the first vehicle longitudinal control model may be defined in a different manner than described above. For example, the layer of nodes may be defined by a distance from a final output node.

The initial input node may refer to one or more nodes within the first vehicle longitudinal control model that receive data directly without passing through links in the relationships with other nodes. Alternatively, within the first vehicle longitudinal control model network, the node may refer to nodes that do not have other input nodes connected by the link, in the relationship between the nodes based on the link. Similarly, the final output node may refer to one or more nodes that do not have the output nodes in the relationship with other nodes within the first vehicle longitudinal control model. In addition, the hidden node may refer to nodes constituting the first vehicle longitudinal control model other than the initial input node and the final output node. According to an embodiment of the present disclosure, the first vehicle longitudinal control model may be a first vehicle longitudinal control model in which the number of nodes in the input layer may be greater than that in the hidden layer closer to the output layer, and the number of nodes decreases as it progresses from the input layer to the hidden layer.

The first vehicle longitudinal control model may include one or more hidden layers. The hidden node in the hidden layer may receive an output of a previous layer and an output of a neighboring hidden node as an input. The number of hidden nodes for each hidden layer may be the same or different. The number of nodes in the input layer may be determined based on the number of data fields in the input data and may be equal to or different from the number of hidden nodes. The input data input to the input layer may be computed by the hidden nodes in the hidden layer and output by a fully connected layer (FCL) which is the output layer.

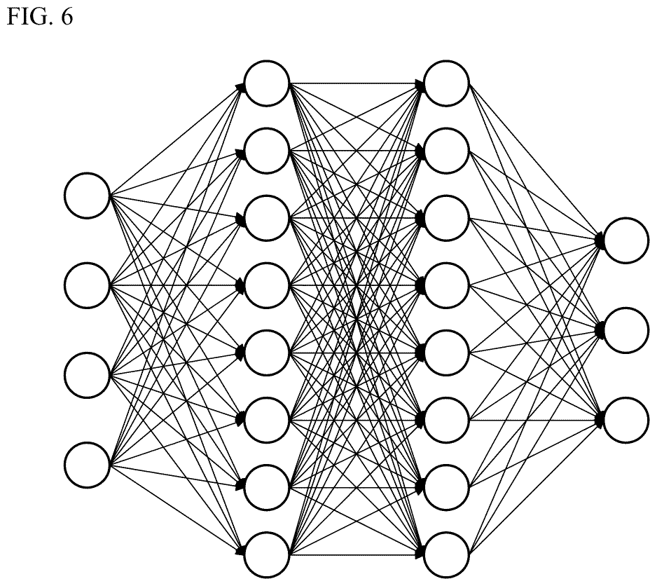

In various embodiments, the first vehicle longitudinal control model may be a deep learning model (e.g., FIG. 6).

The deep learning model (e.g., a deep neural network (DNN)) may be the first vehicle longitudinal control model that includes multiple hidden layers in addition to the input layer and the output layer. It is possible to identify latent structures of data by using the deep neural network. That is, it is possible to identify the latent structures (e.g., what objects are in the photo, what the content and emotion of the text are, what the content and emotion of the audio are, etc.) of a photo, text, video, sound, or music.

The deep neural network may include a convolutional neural network (CNN), a recurrent neural network (RNN), an auto encoder, generative adversarial networks (GAN), a restricted Boltzmann machine (RBM), a deep belief network (DBN), a Q network, a U network, a Siamese network, and the like, but is not limited thereto.

In various embodiments, the network function may include the autoencoder. Here, the autoencoder may be a type of artificial neural network that outputs the output data similar to the input data.

The autoencoder may include at least one hidden layer, and an odd number of hidden layers may be arranged between the input and output layers. The number of nodes in each layer may be reduced from the number of nodes in the input layer to an intermediate layer called a bottleneck layer (encoding) and then expanded symmetrically from the bottleneck layer to the output layer (symmetrical to the input layer). The nodes in the dimensionality reduction layer and the dimensionality restoration layer may or may not be symmetrical. In addition, the autoencoder may perform nonlinear dimensionality reduction. The number of input and output layers may correspond to the number of sensors remaining after preprocessing the input data. In the autoencoder structure, the hidden layer included in the encoder may have a structure in which the number of nodes decreases as it moves away from the input layer. When the number of nodes in the bottleneck layer (the layer with the fewest nodes located between the encoder and the decoder) is too small, a sufficient amount of information may not be transmitted, and therefore the number of nodes may also be maintained at a certain number or more (e.g., more than half the number of nodes in the input layer, etc.).

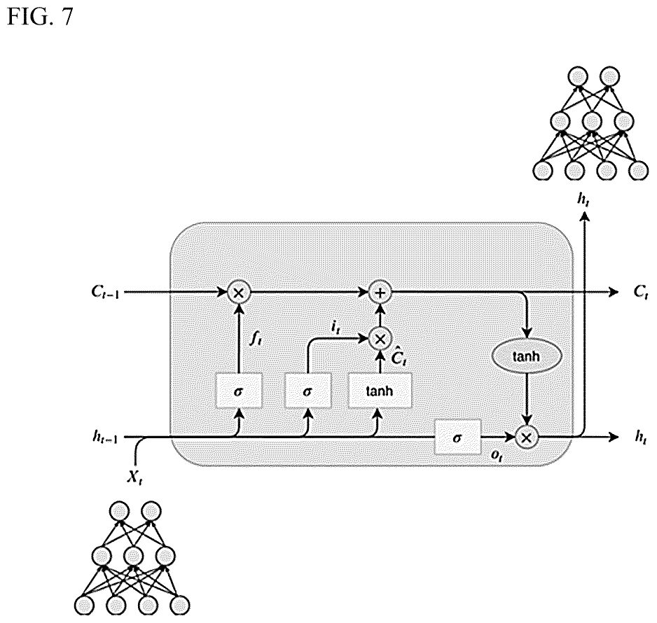

In various embodiments, the first vehicle longitudinal control model may be a Long Short-Term Memory (LSTM) model (e.g., FIG. 7).

The LSTM model is a type of recurrent neural network (RNN) and is a deep learning model for processing data with important temporal dependencies. The RNN has strengths in processing time-series data but suffers from a gradient vanishing problem where past information is forgotten when training long sequences. To address the above problem, the LSTM may manage both long-term memory and short-term memory, providing the ability to maintain important information while forgetting unnecessary information. As described above, in the vehicle control system, the response delay may occur due to the engine and powertrain mechanisms (the inertia of gears, shafts, tires, etc.). Therefore, there are limitations in considering only the data at a specific point in time, and it is necessary to analyze past and/or future data as well. Considering this, as the first vehicle longitudinal control model, the LSTM model, which has strengths in processing time-series data, may be utilized.

That is, the LSTM is a model designed to address the long-term dependency and may effectively memorize the past input information and generate current control commands based on the past input information. This characteristic may be highly advantageous in processing temporal nonlinearities such as the delay of the engine response.

In addition, unlike the conventional control techniques (e.g., PID control, MPC control, etc.) that rely on fixed models, the LSTM may flexibly respond to various driving situations that are difficult for the fixed models to process.

Furthermore, the LSTM-based control model provides significant advantages in real-time control performance. Unlike the existing model predictive controller (MPC controller), the LSTM does not require solving complex optimization problems in real time. This means that the computational cost of generating control commands in real time is low and provides the advantage of being able to quickly adapt to rapid speed changes of a vehicle or unpredictable environmental changes.

In an embodiment, the LSTM-based first vehicle longitudinal control model according to the present disclosure may operate to receive state variables as inputs to process time-series characteristics and control the accelerator pedal based on the processed time-series characteristics. For example, the first vehicle longitudinal control model may be composed of an input encoder, an LSTM cell, and an output layer.

First, the input encoder serves to receive vehicle data as an input and converts the vehicle data into dimensions suitable for the LSTM cell. The vehicle data includes various pieces of vehicle status information, such as engine RPM and a brake pedal position. This data is converted into an encoded vector and transmitted to the LSTM cell.

Second, the LSTM cell receives the encoded input vector provided by the input encoder to process the time-series data. This cell may be a key module that memorizes past driving information and predicts a future state of a vehicle based on the driving information. Through the LSTM cell, the changes in the vehicle state over time may be trained and predicted.

Finally, the output layer may receive the data output from the LSTM cell and generate the final control signal. This layer serves to post-process the output of the LSTM cell to predict the vehicle states, such as the speed or acceleration of the vehicle. Through the output layer, the model may generate actual control signals based on the predicted vehicle states, and thus perform the vehicle longitudinal control.

For example, the LSTM-based first vehicle longitudinal control model may be trained to minimize the error between the target accelerator pedal position value and the estimated accelerator pedal position value (e.g., the measured accelerator pedal position value) using a mean squared error (MSE) loss function.

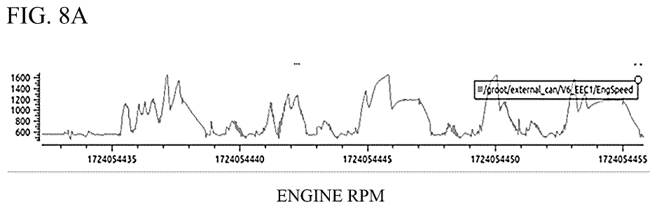

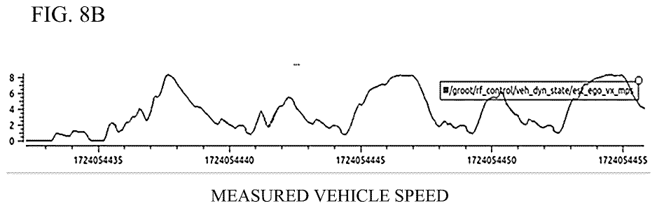

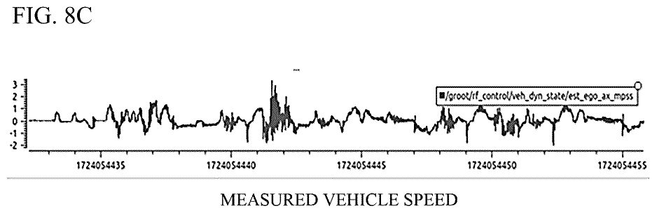

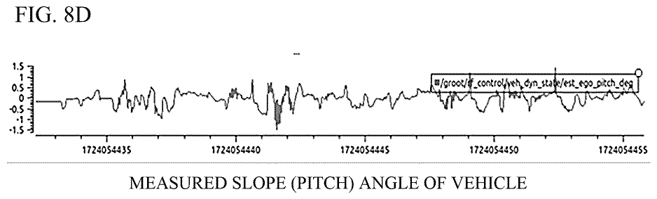

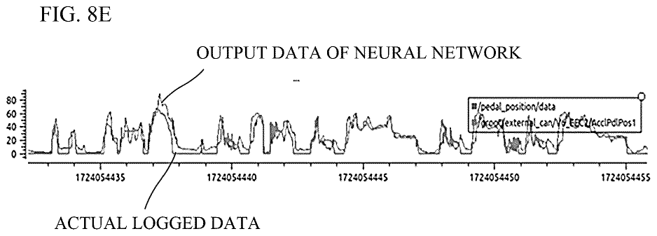

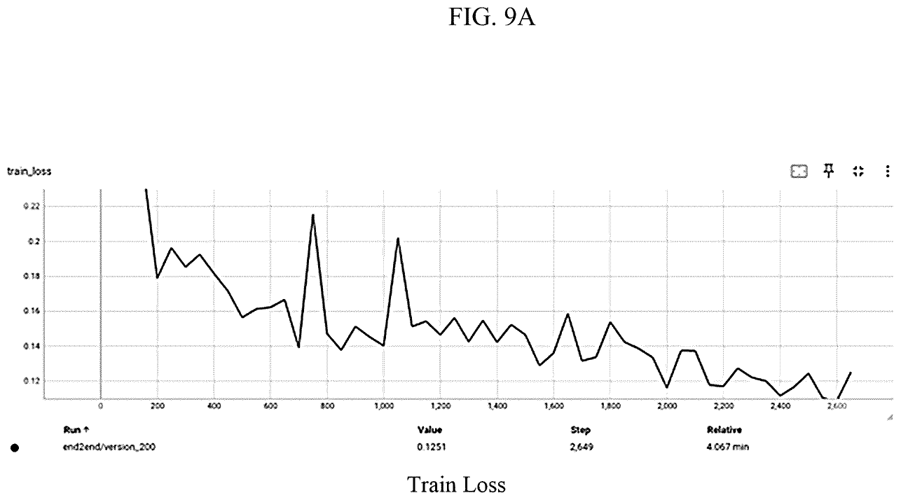

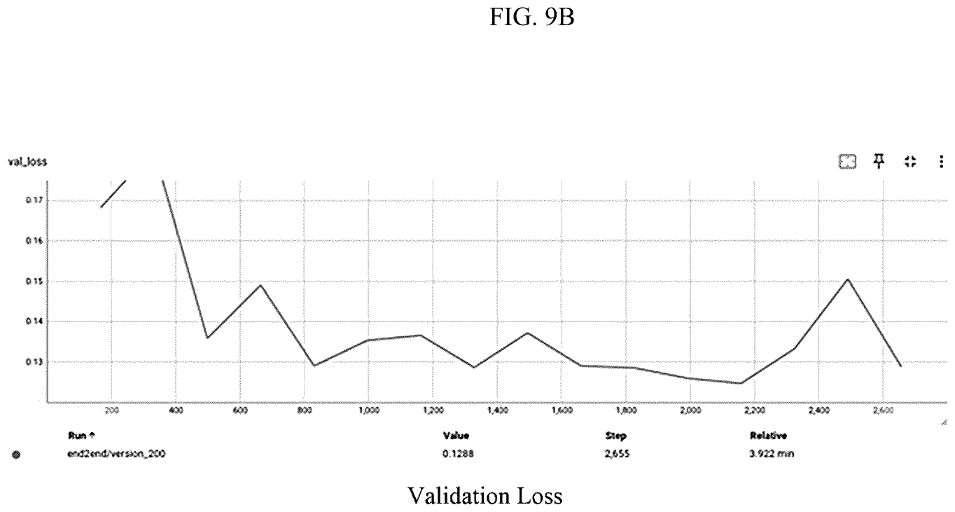

FIGS. 8A to 8E and 9A to 9B illustrate the results of training the first vehicle longitudinal control model using the above-described method. Referring to FIGS. 8A to 8E and 9A to 9B, it may be seen that the first vehicle longitudinal control model accurately predicts the accelerator pedal position information and that the training is performed as both the train loss and validation loss are decreasing.

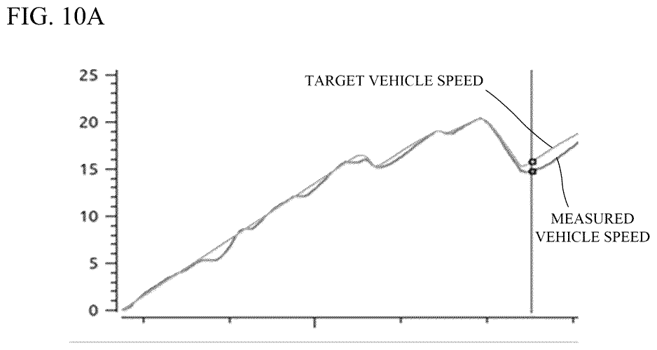

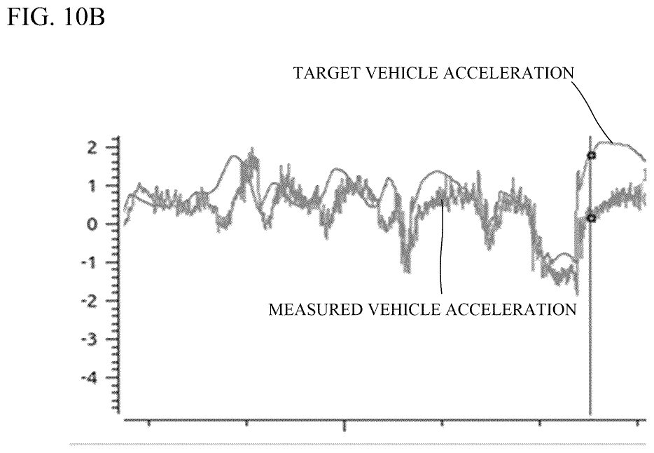

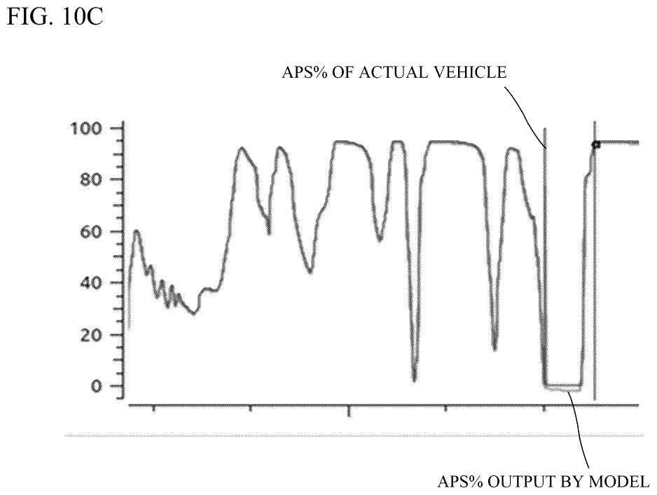

In addition, FIGS. 10A to 10C illustrates the experimental results of the first vehicle longitudinal control model trained according to the above-described method. Referring to FIGS. 10A to 10C, it may be seen that the vehicle 10 is controlled as intended based on the result data derived from the first vehicle longitudinal control model.

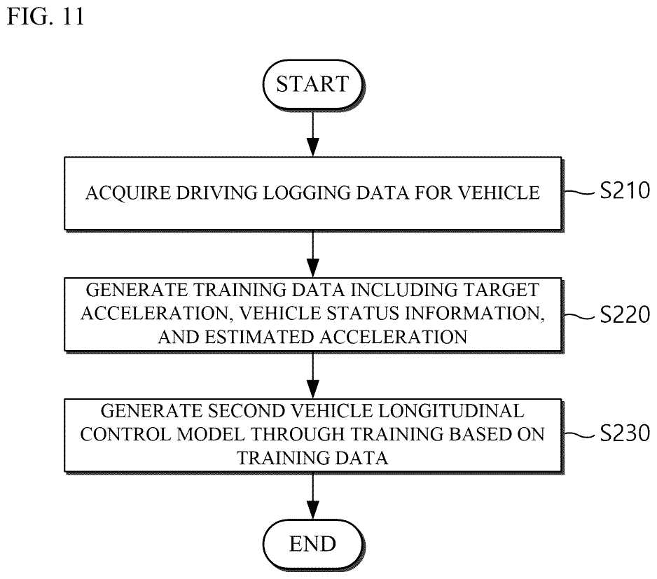

FIG. 11 is a flowchart illustrating a method of generating a second artificial intelligence-based vehicle longitudinal control model for longitudinal control of autonomous vehicles, according to various embodiments.

Referring to FIG. 11, in operation S210, the computing device 100 may acquire the driving logging data for the vehicle 10.

Here, the method of acquiring driving logging data for a vehicle 10 and the driving logging data acquired by the method may be identical and/or similar to the method of acquiring driving logging data and the driving logging data acquired by the method in operation S110 of FIG. 3, but is not limited thereto.

In operation S220, the computing device 100 may generate the training data using the driving logging data acquired through operation S210.

In various embodiments, the computing device 100 may generate training data for training a second vehicle longitudinal control model.

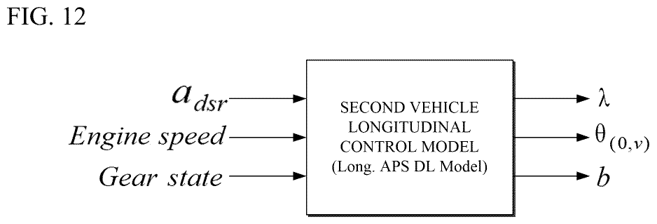

Here, similar to the first vehicle longitudinal control model, the second vehicle longitudinal control model is a model that derives the result data for the vehicle longitudinal control. As illustrated in FIG. 12, the second vehicle longitudinal control model is a model that derives the optimal combination of parameter functions that constitute the vehicle longitudinal model using the target acceleration (a_{dsr}) of the vehicle 10 and the vehicle status information as inputs. The training data may be data that includes the target acceleration, the vehicle status information, and the estimated acceleration.

More specifically, first, the computing device 100 may acquire the target acceleration and the vehicle status information from the driving logging data.

Here, the method of acquiring target acceleration and vehicle status information from driving logging data may be implemented in a form identical to and/or similar to the method in operation S120 of FIG. 3, but is not limited thereto.

Thereafter, the computing device 100 may acquire the estimated acceleration corresponding to the target acceleration and the vehicle status information.

In various embodiments, the computing device 100 may calculate the estimated acceleration using the vehicle dynamics model based on the target acceleration and the vehicle status information. However, the estimated acceleration may be, for example, an actual acceleration measured from the vehicle 10 but is not limited thereto.

Here, the vehicle dynamics model may be expressed as in the following Equation 1.

$${F}_{u} - {R}_{roll} - {R}_{air} - {R}_{g} - {R}_{a} = 0 \qquad < Equation 1 >$$

Here, Fᵤ may denote engine power, Rᵣₒₗₗ may denote rolling resistance, Rₐᵢᵣ may denote air resistance, R_{g} may denote climbing resistance, and Ra may denote inertial resistance.

Next, the computing device 100 may generate the training data that includes the target acceleration and the vehicle status information as the input data, and the estimated acceleration as the ground truth data.

In operation S230, as the computing device 100 trains the second vehicle longitudinal control model using the training data generated through operation S220, the computing device may generate the second vehicle longitudinal control model that derives the optimal combination of parameter functions constituting the vehicle longitudinal model derived from the vehicle dynamics model using the target acceleration and the vehicle status information as the input data.

Here, the configuration and structure of the second vehicle longitudinal control model may be identical to the first vehicle longitudinal control model but are not limited thereto. In addition, the vehicle longitudinal model derived from the vehicle dynamics model may be a model that mathematically expresses the longitudinal movement of the vehicle. For example, the vehicle longitudinal model may be expressed as in the following Equation 2.

$$\dot{v} = - λ ( g ) {θ}_{0} - λ ( g ) {θ}_{v} ( v ) {v}^{2} + b ( g , APS \% ) \frac{APS \%}{100} \qquad < Equation 2 >$$

Here, \dot{v} may denote a vehicle longitudinal control model, λ (g) may denote a parameter function related to a gear scaling factor depending on a gear state, θ₀ may denote a static parameter related to a gear, g may denote the gear state, θᵥ(v) may denote a gear parameter function depending on a speed, v may denote a speed, APS % may denote an accelerator pedal position value, and b(g,APS %) may denote a DC gain function that varies depending on an accelerator pedal position value and the gear state.

In addition, the vehicle longitudinal model \dot{v} may physically denote the longitudinal acceleration of the vehicle 10, and the vehicle longitudinal model may be used to calculate the longitudinal acceleration by considering various factors acting on the vehicle while driving.

The optimal combination of parameter functions to be derived based on the second vehicle longitudinal control model may include, but is not limited to, the parameter function related to the gear scaling factor depending on the gear state (e.g., a function λ(g) related to the gear scaling factor depending on the gear state) (hereinafter referred to as the “first parameter function”), the parameter function related to the gear (e.g., a static parameter θ₀ related to gear and a gear parameter function θᵥ(v) depending on the speed) (hereinafter referred to as the “second parameter function”), and a parameter function b(g,APS %) related to the DC gain that varies depending on the accelerator pedal position value and the gear state (hereinafter referred to as a “third parameter function”).

That is, the computing device 100 trains the second vehicle longitudinal control model using the training data that includes the target acceleration and the vehicle status information as the input data and the estimated acceleration as the ground truth data, thereby generating the second vehicle longitudinal control model capable of deriving the optimal combination of parameter functions that minimizes the error between the target acceleration and the estimated acceleration in the specific vehicle state.

In various embodiments, the computing device 100 may use the training data that includes the target acceleration and the vehicle status information as the input data and the estimated acceleration as the ground truth data, thereby generating the plurality of neural network models as unit models for each of the plurality of parameter functions, and generating a single vehicle longitudinal control model including the plurality of neural network models. That is, after each of the plurality of parameter functions included in the vehicle longitudinal control model is individually designed as a unit neural network model, the vehicle longitudinal control model including the plurality of neural network models may be trained as a single model using the training data to generate the vehicle longitudinal control model.

Each of the parameter functions constituting the vehicle longitudinal model relies on different variables. When a single model is designed to derive various parameter functions without considering the situation, a problem may occur in which the parameter functions may be affected by other variables. For example, even though the first parameter function actually relies on the gear state, when the first parameter function is designed as a single model, a problem may occur in which the first parameter function is affected by factors such as the speed of the vehicle 10 or the engine RPM.

Considering this, the computing device 100 according to the present disclosure may prevent the parameter functions from being influenced by other variables by individually designing the neural network models as unit models for each parameter function. In addition, to train the neural network models to express the actual acceleration of the vehicle 10 well based on the driving logging data of the vehicle 10, the neural network models may be bundled and trained as a single neural network.

Here, the neural network models individually designed for each parameter function may be models that train only the correlation between each parameter function and the information each parameter function relies on.

For example, the first neural network model designed for the first parameter function may be the neural network model that trains only the correlation between the first parameter function and the gear state. In addition, the second neural network model designed for the second parameter function may be the neural network model that trains only the correlation between the second parameter function, the speed, and the gear state. In addition, the third neural network model designed for the third parameter function may be the neural network model that trains only the correlation between the third parameter function, the accelerator pedal position information, and the gear state.

The above-described method of generating an artificial intelligence-based vehicle longitudinal control model for longitudinal control of autonomous vehicles has been described with reference to the flowchart illustrated in the drawings. For simple description, the method of generating an artificial intelligence-based vehicle longitudinal control model for longitudinal control of autonomous vehicles has been described by showing a series of blocks, but the present disclosure is not limited to the order of the blocks, and some blocks may be performed in an order different from that shown and performed in the present specification, or may be performed concurrently. In addition, new blocks that are not described in the present specification and drawings may be added, or some blocks may be deleted or changed.

According to various embodiments of the present disclosure, by constructing the artificial intelligence-based vehicle longitudinal control model capable of deriving the information for the vehicle longitudinal control based on the target acceleration of the vehicle and the vehicle status information and performing the vehicle longitudinal control based on the derived result data, it is possible to more efficiently design the vehicle longitudinal control model.

The effects of the present disclosure are not limited to the above-described effects, and other effects that are not mentioned may be obviously understood by those skilled in the art from the following description.

Hereinabove, although the embodiments of the present disclosure have been described with reference to the accompanying drawings, those skilled in the art to which the present disclosure belongs will appreciate that various modifications and alterations may be made without departing from the spirit or essential feature of the present disclosure. Therefore, it is to be understood that the embodiments described above are illustrative rather than being restrictive in all aspects.

What is claimed is:

1. A method of generating an artificial intelligence-based vehicle longitudinal control model for longitudinal control of autonomous vehicles, which is performed by a computing device, the method comprising:
acquiring driving logging data for a vehicle;
generating training data using the acquired driving logging data; and
generating a vehicle longitudinal control model, which derives result data for vehicle longitudinal control, using the generated training data.

2. The method of claim 1, wherein the generating of the training data includes:
acquiring target acceleration from the acquired driving logging data;
acquiring vehicle status information from the acquired driving logging data;
acquiring accelerator pedal position information from the acquired driving logging data; and
generating training data that includes the acquired target acceleration and the acquired vehicle status information as input data and the acquired accelerator pedal position information as ground truth data.

3. The method of claim 2, wherein the acquiring of the target acceleration includes acquiring acceleration measured from the vehicle at a second point in time, which is a predetermined period of time after a first point in time, as target acceleration at the first point in time.

4. The method of claim 2, wherein the acquiring of the target acceleration includes acquiring an average value of accelerations measured from the vehicle over a predetermined period of time after a specific point in time as target acceleration at the specific point in time.

5. The method of claim 2, wherein the acquiring of the vehicle status information includes acquiring information on a longitudinal speed, engine revolutions per minute (RPM), and a gear state of the vehicle from the acquired driving logging data as the vehicle status information.

6. The method of claim 2, wherein the acquiring of the vehicle status information includes acquiring at least one of slope information of the vehicle and slope change information of the vehicle from the acquired driving logging data as the vehicle status information.

7. The method of claim 1, wherein the generating of the training data includes:
acquiring driving environment information while the vehicle is driving based on previously generated precision map data; and
generating the training data using the acquired driving environment information and the acquired driving logging data, and
the acquired driving environment information includes at least one of a gradient and a gradient change amount of a location where the vehicle is driving.

8. The method of claim 7, wherein the generating of the training data using the acquired driving environment information and the acquired driving logging data includes:
acquiring at least one of slope information and slope change information of the vehicle as vehicle status information based on the gradient and the gradient change amount of the location where the vehicle is driving; and
generating the training data using the at least one acquired information and the acquired driving logging data.

9. The method of claim 1, wherein the generated vehicle longitudinal control model is a long short-term memory (LSTM) model.

10. The method of claim 1, wherein the generating of the training data includes:
acquiring target acceleration from the acquired driving logging data;
acquiring vehicle status information from the acquired driving logging data;
extracting an estimated acceleration corresponding to the acquired target acceleration and the acquired vehicle status information; and
generating training data that includes the acquired target acceleration and the acquired vehicle status information as input data and the extracted estimated acceleration as ground truth data, and
the generating of the vehicle longitudinal control model includes generating the vehicle longitudinal control model that derives an optimal combination of parameter functions constituting a vehicle longitudinal model derived from a vehicle dynamics model by training the vehicle longitudinal control model using the generated training data.

11. The method of claim 10, wherein the generating of the vehicle longitudinal control model that derives the optimal combination of the parameter functions constituting the vehicle longitudinal model includes:
when the vehicle longitudinal model includes a plurality of parameter functions, generating a plurality of neural network models as unit models for each of the plurality of parameter functions; and
generating a single vehicle longitudinal control model including the plurality of generated neural network models.

12. The method of claim 10, wherein the vehicle dynamics model is expressed as in the following Equation 1,
$${F}_{u} - {R}_{roll} - {R}_{air} - {R}_{g} - {R}_{a} = 0 \qquad < Equation 1 >$$
where Fᵤ denotes engine power, Rᵣₒₗₗ denotes rolling resistance, Rₐᵢᵣ denotes air resistance, R_{g} denotes climbing resistance, and Ra denotes inertial resistance.

13. The method of claim 10, wherein the vehicle longitudinal model is expressed as in the following Equation 2,
$$\dot{v} = - λ ( g ) {θ}_{0} - λ ( g ) {θ}_{v} ( v ) {v}^{2} + b ( g , APS \% ) \frac{APS \%}{100} \qquad < Equation 2 >$$
where \dot{v} denotes the vehicle longitudinal control model, λ(g) denotes a parameter function related to a gear scaling factor depending on a gear state, θ₀ denotes a static parameter related to a gear, g denotes the gear state, θᵥ(v) denotes a gear parameter function depending on a speed, v denotes the speed, APS % denotes an accelerator pedal position value, and b(g,APS %) denotes a DC gain function that varies depending on an accelerator pedal position value and the gear state.

14. The method of claim 10, wherein the derived optimal combination of the parameter functions includes a parameter function related to a gear scaling factor depending on a gear state, a parameter function related to a gear, and a parameter function related to a DC gain that varies depending on an accelerator pedal position value and the gear state.

15. The method of claim 1, wherein the generating of the training data includes:
preprocessing the acquired driving logging data; and
generating the training data using the preprocessed driving logging data.

16. A computing device that performs a method of generating an artificial intelligence-based vehicle longitudinal control model for longitudinal control of autonomous vehicles, the device comprising:
a processor;
a network interface;
a memory; and
a computer program loaded into the memory and executed by the processor,
wherein the computer program includes:
an instruction to acquire driving logging data for a vehicle;
an instruction to generate training data using the acquired driving logging data; and
an instruction to generate a vehicle longitudinal control model, which derives result data for vehicle longitudinal control, using the generated training data.

17. A computer-readable recording medium on which a computer program is recorded, wherein the computer program is coupled to a computing device to execute a method of generating an artificial intelligence-based vehicle longitudinal control model for longitudinal control of an autonomous vehicle, wherein the method includes:
acquiring driving logging data for a vehicle;
generating training data using the acquired driving logging data; and
generating a vehicle longitudinal control model, which derives result data for vehicle longitudinal control, using the generated training data.
